(19) United States
(12) Patent Application Publication
(10) Pub. No.: US 2007/0021940 A1
(43) Pub. Date: Jan. 25, 2007

(54) Use of imaging innovations for design and modification

(76) Inventors: Sarah Peter, Los Angeles, CA (US); Elizabeth Thomas, San Jose, CA (US)

Correspondence Address: Sarah Peter, 11352 Thurston Place, Los Angeles, CA, 90049, US

(21) Appl. No.: 10/369,861

(22) Filed: Feb. 21, 2003

(51) Int. Cl. G01B 15/00

(52) U.S. Cl. 702/155

(57) ABSTRACT

A method for making and using automated non-contact measurements of the customer's body or limb structure, for applications is disclosed. Typical applications are manufacture of garments, including men's suits, pants, shirts and ladies dresses, pant-suits etc. The method of measurements can also be used for ergonomically designing products suitable for individuals, like car seats for high-end cars, office furniture, taking the correct dimensions of the individual for whom the design is being made. This type of measurements can be used for making wheel chairs and other similar items for the handicapped. It is also modifiable for making measurements of limbs (hands and legs) and body parts to fit prosthetics for the handicapped.

### FIELD OF INVENTION

This invention relates to making direct and accurate measurement of an individual's body by means of remote sensing methods and using these accurate measurements for manufacture of items fitted for the individual.

### PRIOR ART

The art of garment making and fitting has evolved over the years. There are now pre-fabricated garments, pants, suits, shirts etc., for men and dresses, pant-suits etc, for women, available through bulk manufacture. But to get a good fit it is always necessary to have a made to order product which needs accurate measurements of the individual's body structure and a number of fitting and adjustment before it is complete. The measurements are typically done by expert tailors or dress makers and the fitting is done by the ordering individual going back, one or more times, to wear the partially made garment and re-adjusting the garment to make it correct fit to the structure, a very tedious process. This also limits the freedom of the manufacturer and the customer, as access becomes important to the completion of the project.

Similarly ergonomic design of furniture and other ergonomic user-friendly items have been done by taking direct measurements of the individual for whom the designs have to be fitted. These measurements are then sent over to the manufacturing facility for custom manufacture of the item. Any errors make the item unusable by the individual. In addition the process itself is a very tedious one and makes the items very expensive to make and be made universally available.

### OBJECTS AND ADVANTAGES

What is proposed is a way of taking reliable direct measurements of an individual's body, for accurate modeling using imaging techniques and distance scanning methods, typically using ultra-sound, laser, infrared, or other types of scanning and sensing suitable for the purpose. The proposed measurements are non-contact and non-intrusive in nature. This type of measurements also provide the advantage of ease of taking measurement with substantial improvement in accuracy over individual manual measurements, provide a complete set of measurements which can be used for automated design, provide a way of making accurate measurements available at the manufacturing location for modeling and check out of the final design by making it possible to transmit the collected data over the communication media.

### DESCRIPTION OF DRAWINGS

FIG. 1—Example Diagram of a proposed typical enclosure with sensor array for taking the measurements—with rotating platform

FIG. 2—A second example of proposed measurement setup—with rotating sensor setup

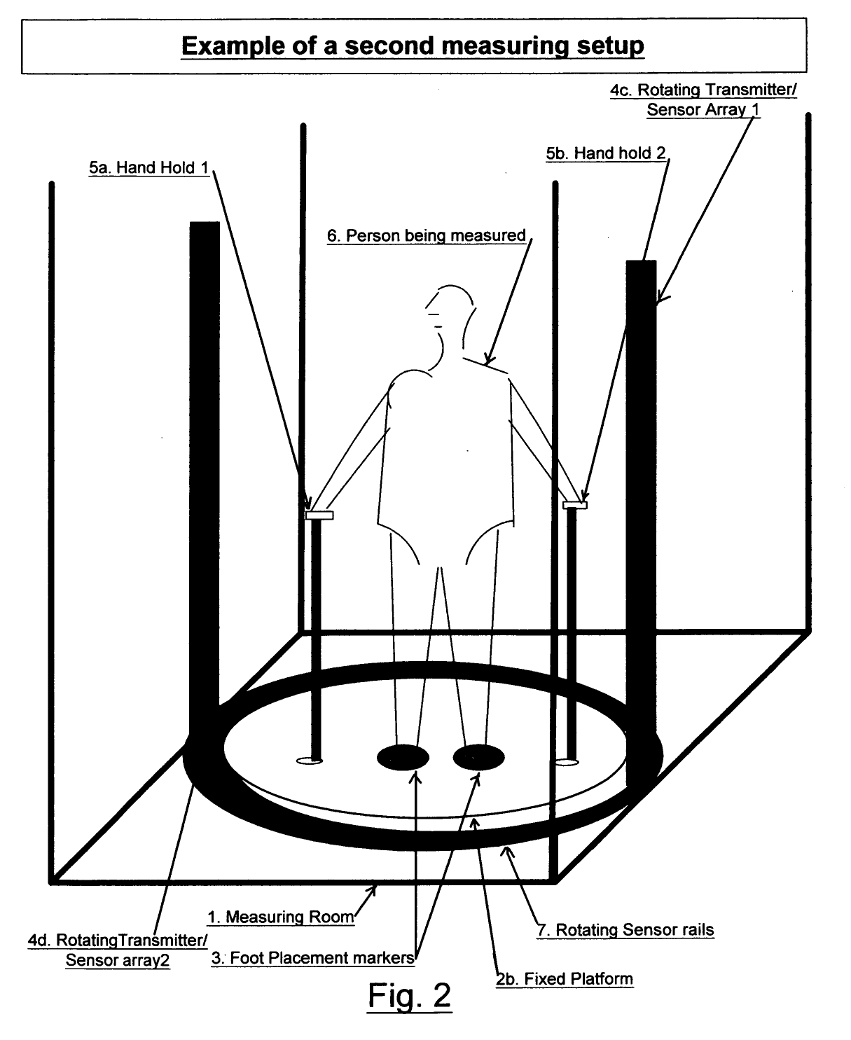

FIG. 3—A third example of the proposed measuring setup—with sensor array on a ring sliding vertically.

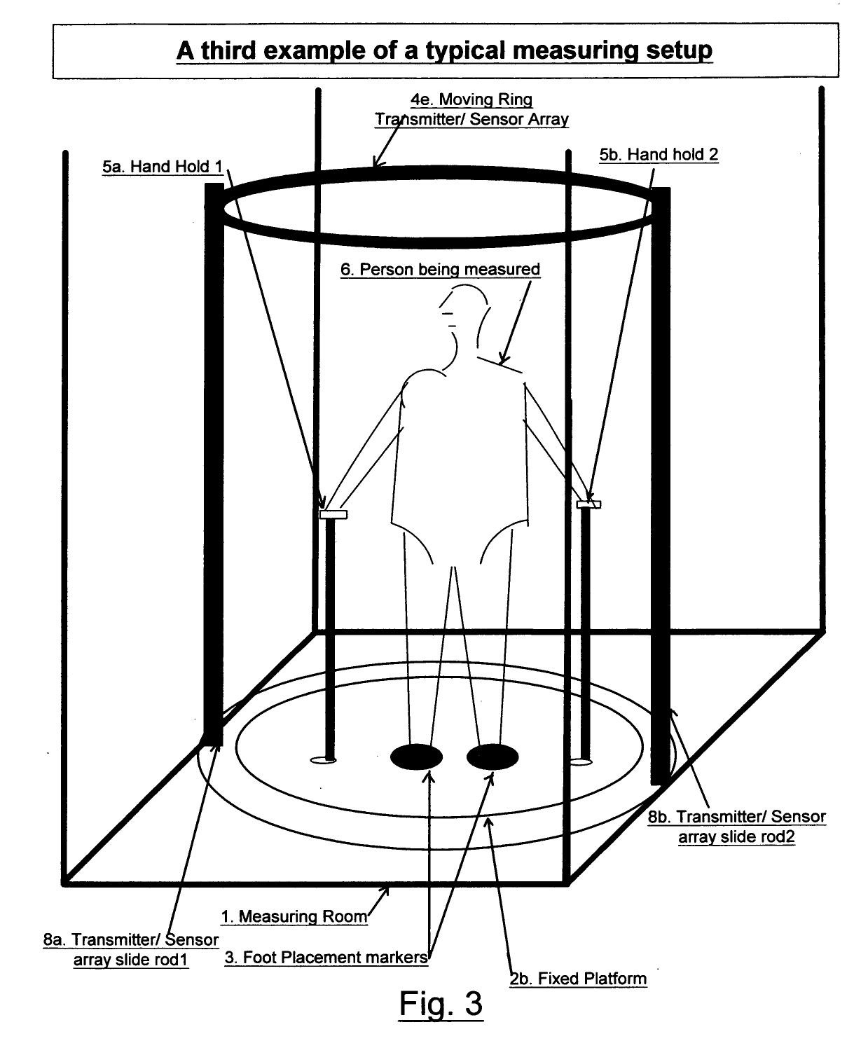

### DRAWING NUMERALS IN FIGURES

1. Measuring room or enclosure
2. Standing platform
   a. Rotating platform
   b. Fixed Platform
3. Foot placement markers
4. Transmitter/Sensor Array
   a. Fixed Transmitter/Sensor Array 1
   b. Fixed Transmitter/Sensor Array 2
   c. Rotating Transmitter/Sensor Array 1
   d. Rotating Transmitter/Sensor Array 2
   e. Ring Transmitter/Sensor Array
5. Hand hold
   a. Hand hold 1
   b. Hand hold 2
6. Individual being measured
7. Rotating Sensor Rails
8. Transmitter/Sensor Array Slide rod
   a. Slide rod 1
   b. Slide rod 2

### SUMMARY OF INVENTION

A method for making and using automated non-contact measurements of the customer's body or limb structure, for applications is disclosed. Typical applications are manufacture of garments, including men's suits, pants, shirts and ladies dresses, pantsuits etc. The method of measurements can also be used for ergonomically designing products suitable for individuals, like car seats for high-end cars, office furniture, taking the correct dimensions of the individual for whom the design is being made. The measurement can, typically, be done in a measuring enclosure inside the measuring (dressing) room where the individual is automatically scanned using non-contact, measuring sensors, which may be of the type using ultra-sound, laser, infrared or any other available types. These measurements can then be, typically, used directly to design the garment and also to define (design) cut the size and shape of the pieces of clothing for making the garment a perfect fit. Using the measurements a computer model of the body can be made and the designs can be modeled, for modification and approval, by the individual, before it is manufactured. These dimensions can be transmitted over the communication channels for remote design and manufacture of the garment, and if so desired, for developing an accurate mannequin (model) for use in checking the designed product.

Similar measuring techniques and measurements can also, typically, be used for ergonomic design of furniture and other items optimized for the individual. This can be at a local facility, or transmitted over communication channels to remote facility for design and manufacture of the items there. The measurements can be used to generate model of the individual to aid in computer-aided design of the furniture. Similarly mannequins can be made to ensure that the furniture is exactly suited tom the customers needs. The same methods with suitable scaled and modified measuring enclosures can be used to measure a limb or other specific areas of the body for manufacture of prosthetics or other equipment for the handicapped.

There will be many other applications for which these same or similar measuring procedures can be used, with suitable modifications to the measuring chamber, as will be clear to the practitioners of the art, which have not been enumerated here. It is expected that many such modifications will suggest themselves to those skilled in the art having the benefit of the disclosure. These illustrative descriptions should not be considered as limiting the scope of the invention

### INVENTION DETAILS AND TYPICAL APPLICATIONS

One area where the proposed measurements will be very useful is in the Garment industry. In the garment making arena this will enable the master tailor or dressmaker to be exact in the initial design process of the garment, so that it will fit the person for whom it is made. These measurements also allow the garment maker to make a model of the body (mannequin) to fit the garment as it is being made.

These measurements also allow automation of the garment design process and computer simulation of the garments, on individual's measurement based model, to be displayed and approved, with any and all changes to it as desired, by the individual before decisions to make are finalized.

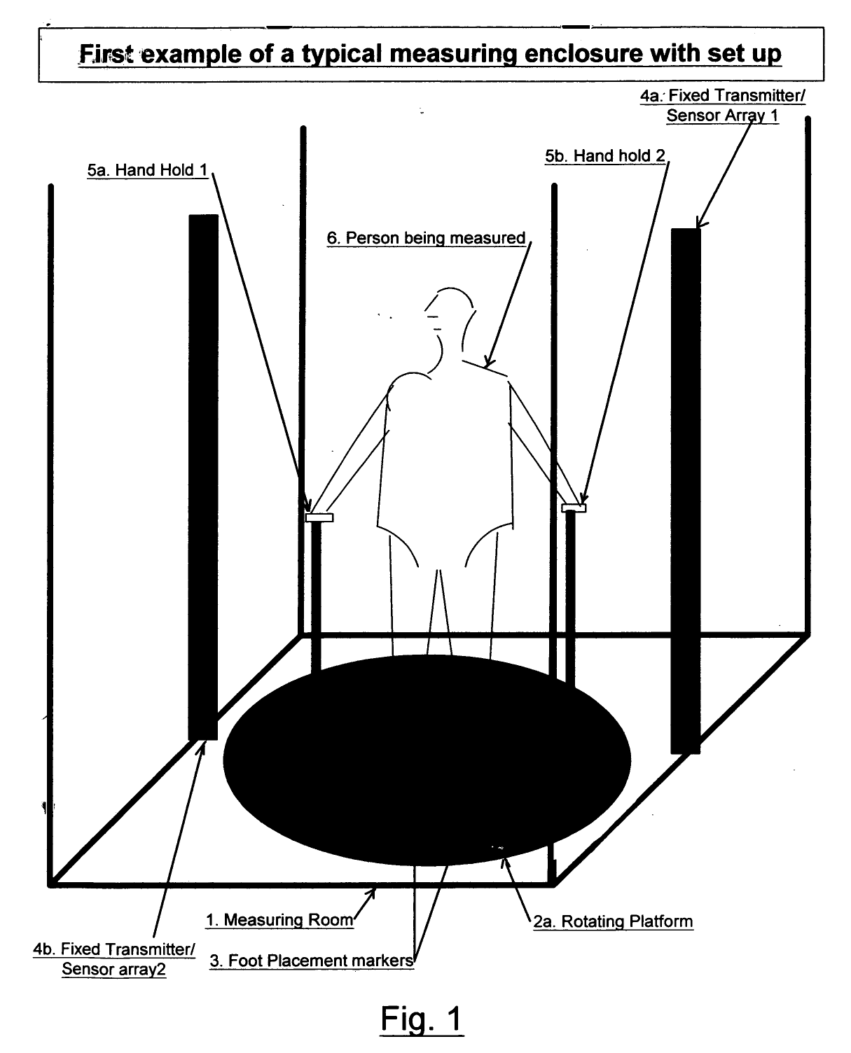

The details of the invention can be best explained by taking the example of non-contact measurement for garments explained above. FIG. 1 shows a typical measurement set up. The measuring room (1) has multiple transmit and sense arrays (4a and 4b) to generate and sense the signals, two such arrays are shown in the picture as stationary arrays. In the typical implementation shown a rotating platform is used to make sure all round measurements could be taken (2). Since the measurements take a short period of time and the individual has to be stationary during that period, a set of foot placement markers (3) and a pair of hand holds (5a and 5b) are provided. The switches for adjusting the height of sensing, (as measurement for garments need to be taken from neck down only and the height of sense array need to be adjusted to suite the height of the individual), and the switch for start and stop of the rotating platform can be conveniently placed on the hand holds (5a and b) in a typical implementation. During operation the individual who is to be measured changes to his under garments in the privacy of the room and stands on the platform with his feet placed on the foot markers. He then holds himself steady by placing his hands on the handholds. Once he has made sure he is comfortable and steady, he can initiate the platform rotation to allow all round measurements to be taken. Once the measurements are complete and recorded the platform stops rotating. He can then dress and go out of the room and check to make sure the measurements are correct from the graphic display of him on a computer, made from the measurements taken.

Though in the typical implementation a rotating platform is shown, a rotating sensor array with a stationary platform or other such variations are possible for implementing this measuring room for garment measurements. Similarly other suitable measuring enclosures can be used for limbs of individuals without going into such an elaborate room, in the case of measurements for prosthetics.

The measurements also enable automation of the garment design process, by having the correct measurements pieces of cloth for making the garment can be designed using automated methods and accurately cut with minimum loss or margin for adjustments due to measurement errors, allowing for fast manufacture at a lower cost. The capability that the measurements are collected in a form suitable form for transmission over the digital communication channels allow them to be transmitted to the design person at remoter location for completion of design. This eliminates the need that exists today for the customer to travel to the designer for taking individual measurements and design the dress with these measurements. In addition as it is practiced today the customer has to go in for fitting of the dress, sometimes multiple times, with the added expenditure in time and money. This effort can also be reduced or even eliminated by making a computer model of the customers body (today three dimensional models which can be moved around are possible) for modeling the design and getting the approval of the person before the actual manufacturing process starts, and using a scale model mannequin of the customers body for try out of the finished product before the customer tries it on, and or shipping it to the customer.

Remote location manufacturing is also made easier with this method. The design and the measurements can be sent to the most optimum manufacturing location to take advantage of the costs without either the customer or the expertise of a designer being present at the location. This will make custom designed garments, which today are only available to the rich and famous, more accessible to the common man. A second typical application that can be immediately seen is the use of the measurements for manufacture of ergonomically fitting items of furniture and similar items to suite an individual's need in the work place. Work related injuries are becoming a major item of concern in the work place. Companies are going out of their way to provide suitable environment in terms of furniture and facilities to minimize this type of injuries to valuable employees. Today making ergonomically friendly furniture for home and office is a very expensive proposition and almost an impossible task. This is true for fitting the furniture to the person, as individual measurements have to be manually taken for this purpose. Using the proposed automated measuring technique a set of measurements can be taken and stored which will allow available furniture to be fitted to suit the person and if not available, to make them to fit as needed. Again due to the reduced errors in measurements and by using remote manufacturing, the cost to make these facilities available to common man can be brought down. The capability of transmitting the measurements over communication channels to remote sites to take advantage of the cost of manufacture and the availability of expertise will reduce the final price and make these furniture more widely available.

A third typical application is that these disclosed measurements would also be a help to disabled individuals for whom wheel chairs and similar furniture and apparatus have to be custom fitted and later modified. The need for them to travel to the fitting location for measurements and fitting can be substantially reduced and life made more comfortable for them. The method can be used effectively for taking measurements of limbs and other parts of the body for correct fitting of prosthetics and other devices for the handicapped.

A fourth typical application is for measurements of a disabled individual's limbs or part thereof, from which prosthetics for the individual can be made. For this purpose the measuring chamber can be modified and even made portable. The accurate measurements will enable computer modeling and computer aided design for correct fitting of the prosthetic. Physical models made from the measurements can also be used to enable correct and comfortable fit of prosthetic before it is sent out from the manufacturing center. Here again remote site manufacturing and use of off site experts for optimum design and manufacturing is possible by sending the data/computer model over already existing communication channels to the remote sites.

Other applications not discussed here will exist which will become clear to the implementers and users and we expect a multitude of other uses for this measuring capability once established.

What is claimed is:

1. A method of making reliable direct measurements of an individual's body, by distance scanning methods.

2. The method of making reliable direct measurements of claim 1, where in said methods are non-contact and non intrusive.

3. The method of making reliable direct measurements in claim 1, where in the distance scanning is by laser.

4. The method of making reliable direct measurements in claim 1, where in the distance scanning is by ultrasound.

5. The method of making measurements in claim 1, where in the distance scanning is by infrared.

6. A method for making and using measurements of the customer's body, taken by automated non-contact means, for garment making.

7. The method of making and using measurements of the customer's body in claim 6, where in the measurements are used in the design of the garment, which exactly fit the individual for whom it is made.

8. The method of making and using measurements of the customer's body in claim 6, wherein the measurements are used in making a mannequin to fit the garment during manufacture.

9. The method of making and using measurements of the customer's body in claim 6, wherein the measurements are used to automate garment design.

10. The method of making and using measurements of the customer's body in claim 6, wherein the measurements allow computer simulation of the garments, on computer model, based on individuals measurement, to be displayed and approved, by the individual before decisions to make are finalized.

11. The method of making and using measurements of the customer's body in claim 6, wherein the measured dimensions can be transmitted over the communication channels for remote design centers for taking advantage of the expertise of designers available at that location.

12. The method of making and using measurements of the customer's body in claim 6, wherein the measured dimensions can be transmitted over the communication channels for remote manufacture of the garment for taking advantage of optimum manufacturing capability.

13. A method for making and using measurements of the customer's body, by automated non-contact means, for use in ergonomic design of furniture.

14. The A method for making and using measurements of the customer's body, by automated non-contact means, for use in ergonomic design of furniture in claim 13, where in the furniture can be wheel chairs and similar for the disabled.

15. The method of making and using automated non-contact measurements of the customer's body in claim 13, wherein the measured dimensions can be transmitted over the communication channels for remote design and manufacture for cost savings.

16. The method of making and using automated non-contact measurements of the customer's body in claim 13, wherein the measured dimensions can be used for modeling and computer aided design of the furniture to suit the individual measured.

17. The method of making and using automated non-contact measurements of the customer's body in claim 13, wherein the measured dimensions can be used for making mannequins that can be used to make sure that the furniture made is suitable for the individual measured.

18. A method for making and using measurements of a disabled individual's limbs or part thereof, by automated non-contact means, for the purpose of manufacturing prosthetics for the individuals use.

19. The method for making and using measurements of a disabled individual's limbs or part thereof, by automated non-contact means, in claim 18, where in the measurements can be used to generate computer model the limbs for computer aided design of the prosthetic.

20. The method for making and using measurements of a disabled individual's limbs or part thereof, by automated non-contact means, in claim 18, where in the measurements can be used for manufacture of a model of the limb to ensure comfortable fit of the prosthetic.
